(19) United States
(12) Patent Application Publication
(10) Pub. No.: US 2015/0142291 A1
(43) Pub. Date: May 21, 2015

(54) METHOD OF OPERATING AN IN-LINE SIX CYLINDER ENGINE IN A VEHICLE

(71) Applicant: LIPPITT ENGINE, LLC, Smithfield, NC (US)

(72) Inventors: Raymond F. Lippitt, Smithfield, NC (US); Guy M. Mason, Selena, NC (US)

(21) Appl. No.: 14/568,823

(22) Filed: Dec. 12, 2014

Related U.S. Application Data
(63) Continuation-in-part of application No. PCT/US2013/070387, filed on Nov. 15, 2013.

(51) Int. Cl. F02B 75/18; F02D 41/30; F02D 41/38; F02B 75/20

(52) U.S. Cl. CPC F02B 75/1896; F02B 75/20; F02D 41/3017; F02D 41/38; F02B 2075/1824; F02D 2041/389
USPC 701/93; 123/294

(57) ABSTRACT

An internal combustion engine having six in-line piston and cylinder assemblies providing a center pair, an intermediate pair and an outer pair, each pair having crankshaft connected pistons mounted in cylinders through simultaneous repetitive strokes four of which together constitute simultaneous repetitive cycles including a drive event injectors selectively (1) in a (Mode 1) to inject fuel in both cylinders and (2) in a (Mode 2) to inject fuel in only one cylinder, the cylinders of the center pair being intercommunicated by a passage. The effect of skipping an injection in (Mode 2) in the center pair is a pair of shared power drive events and in the other pairs the effect in one of the cylinders is a directly fired power drive shaft and the effect in the other cylinder is deactivation and a method of operating the engine in a vehicle.

### CROSS-REFERENCE APPLICATIONS

The present application is a continuation-in-part of International Patent Application No. PCT/US2013/070387, bearing an international filing date of Nov. 15, 2013, which was published on Sep. 18, 2014 as No. WO 2014/143211, in turn claiming priority to U.S. patent application Ser. No. 13/839,992, filed Mar. 15, 2013, the entirety of each of which is incorporated herein by reference.

### FIELD OF INVENTION

This invention relates to the operation of internal combustion engines having fuel saving operating modes of the type disclosed in U.S. Pat. No. 8,443,769, the entire disclosure of which is hereby incorporated herein by reference.

### BACKGROUND OF THE INVENTION

The fuel saving modes of the '769 patent involve a step forward in the evolution of “skipping” technology. A skipped piston and cylinder is one that does not receive an injection of fuel during the injection stroke in which fuel would normally be injected. For the first time, the piston of the skipped piston and cylinder assembly actually enters into the creation of power rather than simply being neutral or requiring power from the rest of the engine to be moved through repeated cycles without cycle events taking place. The skipped piston enters into the creation of power by means of a passage between the combustion chambers of two paired assemblies. The increased pressure conditions in the cylinder of its paired assembly resulting from the internally fired power drive stroke therein is communicated by the passage to the skipped cylinder, causing the skipped piston to undergo a simultaneous shared power drive stroke. Since the skipped piston is directly connected to the crankshaft, its shared power drive stroke creates power in the engine.

### BRIEF DESCRIPTION OF THE INVENTION

The above-incorporated priority patent applications disclose an in-line six engine embodying the skipping principles of the '769 patent which is disclosed as being operated by methods which select the power level step of operation resulting in operation characterized by possible abrupt steps.

The present invention is concerned with providing the in-line six cylinder engine with the ability to operate by an improved method characterized by smooth transitions between steps of operation.

The method of operating the engine according to the invention is basically similar in many respects to the way most vehicle engines are operated. That is, after first establishing the idling operation of the engine with the vehicle stationary and the gear shift in neutral, the movement of the vehicle by the engine is made to take place with the gear shift in a drive position at a speed which is responsive to how far down the accelerator pedal is pushed from its initial toward its maximum position. The difference of the present invention lies in the fact that the engine in operation has three pairs of piston and cylinder assemblies subject every cycle to the dual options of the '769 patent of making the engine capable of being operated in four power level steps involving four different numbers of fuel injections, and the procedure by which these steps are selected each with an increasing or decreasing fuel amount per injection so as to achieve a smooth transition between the steps in response to the movement of the accelerator pedal in either direction between idle and maximum position.

The procedure involves transmitting pedal position signals to a controller, such as a computer, processing the signals in the computer to determine which of four progressive zones of pedal positions, the pedal is in.

Then, after making the determination of which zone the pedal position is in, transmitting zone signals to the injectors of the three pairs of piston and cylinder assemblies indicative of the zone within which the position of the pedal lies. These zone signals are like step identifying signals when received by the injectors causing them to respond so that the three pairs of assemblies operate in a corresponding power level step. That is, a zone signal for a given zone is the collective signals output to the fuel injectors selected from fuel injection in that zone.

The pedal position signals are also processed so that the computer controls the amount of fuel per injection to accomplish a smooth progressive increase and decrease in the power delivered by the engine in response to the movement of the accelerator pedal from the initial position through the transition positions to the maximum position and reverse. That is, within a given zone, the amount of fuel injected by the fuel injectors selected for that zone may be varied as well.

The method also involves the use of a sensor capable of sensing the activation and continued operation of the cruise control system to modify the method of operating the three pairs of assemblies so that they remain in the low power level step with power variation in response (via the pedal positions) to the automatic signals system movement of the position of the accelerator pedal until the system is deactivated.

Other objects, features, and advantages of the present invention will become apparent from the following detailed description, the accompanying drawings, and the appended claims.

### DESCRIPTION OF THE DRAWINGS

FIG. 1 is a perspective view of a conventional in line six cylinder engine with parts broken away for purposes of clearer illustration.

FIG. 2 is a perspective view of a first modification in accordance with the principles of the present invention in the form of a new crankshaft.

FIG. 3 is a fragmentary perspective view of a second modification in accordance with the principles of the present invention in the form of a passage in the engine block between cylinders 3 and 4.

FIG. 4 is a schematic and block diagrammatic view of a third modification in accordance with the principles of the present invention in the form of a modified fuel injecting and firing system.

FIG. 5 is a schematic view showing the engine of FIGS. 1-4 mounted in a vehicle and connected with the usual components of the vehicle so as to be operated in accordance with the method of the present invention.

### DETAILED DESCRIPTION OF THE INVENTION

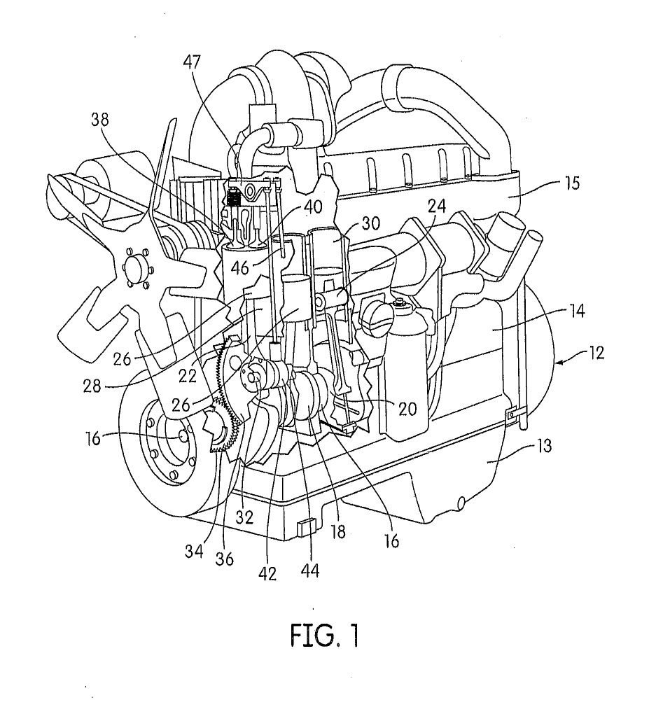

FIG. 1 shows a prior art six cylinder in line diesel engine 10 which includes a main frame 12 having a pan 13 detachably fixed to the lower end of a crankcase portion 14 thereof. Mounted within the crank case portion 14 is a crankshaft 16 journaled in main bearings 18. The crankshaft 16 includes six crankpin bearings 20 on which the bolt secured split ends of six connecting rods 22 are journaled. The opposite ends of the six connecting rods 22 are journaled in six wristpin bearings 24 mounted within six pistons 26 respectively. The six pistons 26 are in-line oriented slidably sealingly mounted in six in-line oriented cylinders 28 formed by six in-line oriented cylinder liners 30 removably fixed within the frame 12.

The connecting rods 22 are journaled at one end of the crankshaft 16 and at the other end on the pistons 26 which causes the pistons 26 to be reciprocated within the cylinder liners 30 through a cycle of four reciprocating strokes while the crankshaft is rotated through two rotations.

The four events which occur within the cylinders 28 during each four stroke cycle include, in order, intake compression, fire, and exhaust. The events are accomplished in response to a camshaft 32 which is suitably journaled on the frame 12. The camshaft 32 is mounted in a position to be driven by the crankshaft 16. The drive is accomplished by a gear 34 fixed on the crankshaft 16 to rotate therewith and a meshing gear 36 of twice the size of gear 34 fixed on the camshaft 32 so that the camshaft 32 rotates at half the speed of the crankshaft 16.

The four events are accomplished by reciprocating inlet valves 38 spring biased to close inlet openings leading into the cylinders 28 above the pistons 26 and outlet or exhaust valves 40 spring biased to close outlet openings leading from the cylinders 28 to an exhaust manifold (not shown) forming a part of an exhaust system including an exhaust pipe (not shown).

The inlet and outlet valves 38 and 40 are moved into opening relation to the inlet and outlet openings against their spring bias by inlet and outlet cam lobes 42 and 44 on the camshaft 32 which move inlet and outlet lifter rods 46. The inlet and outlet valves 38 and 40 are actively moved by one ends of inlet and outlet rocker arms 47, the other ends of which are moved by the inlet and outlet lifter rods 46.

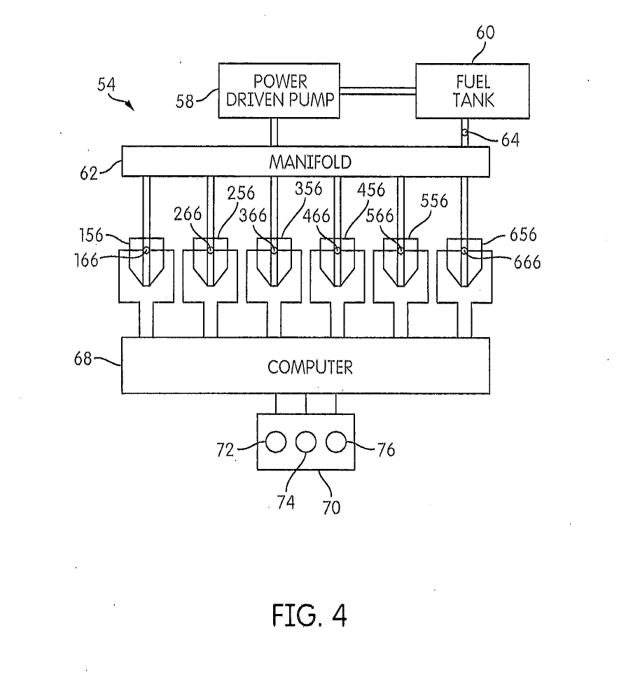

The position of the cam lobes 44 on the camshaft 32 cause (1) the inlet valve 38 associated with each cylinder to be open at an appropriate time so that the inlet opening is open during the inlet stroke event of the cylinder cycle (2) cause the outlet valve 40 associated with each cylinder to be opened at an appropriate time so that the outlet opening is open during the outlet or exhaust stroke event. The inlet and outlet valves 38 and 40 are allowed to remain in their spring biased closed position during the compression stroke event of each cycle wherein the air in the cylinder taken in during the intake stroke event is compressed to an auto ignition pressor. The inlet and outlet valves 28 and 30 also remain closed during the firing stroke during which diesel fuel is injected into the cylinder by a computer controlled fuel injecting and firing system, generally indicated at 48; modification of which is shown in FIG. 4 and will be described in detail hereinafter.

It will be understood that the conventional in-line six cylinder engine also has accessories such as an alternator, fuel and air filters, an oil pump, a turbo charger, a super charger, etc., which remain unmodified in accordance with the principles of the present invention and hence are either not shown in the drawings or described in detail herein.

It can be seen that the conventional engine 10 includes six in-line crankshaft driven piston and cylinder assemblies, which can be conveniently identified from left to right as 1 through 6 respectively. Each of the piston and cylinder assemblies 1-6 includes a cylinder liner 30, a piston 26 and a connecting rod 22, which can be referred to as cylinder 1, piston 1 or connecting rod 1, cylinder 2, piston 2 or connecting rod 2, etc., for purposes of clearly identifying each one of six.

The six crank portions of the crankshaft 16 are arranged so that pistons 1 and 6 move together in cylinders 1 and 6, pistons 2 and 5 move together in cylinders 2 and 5 and pistons 3 and 4 move together in cylinders 3 and 4. A conventional firing order is 153624 which means that the firing stroke event takes place in successive strokes, first in cylinder 1; second in cylinder 5; third, in cylinder 3; fourth, in cylinder 6; fifth, in cylinder 2; and sixth, in cylinder 4. A cycle must take place in each cylinder in two rotations of the crankshaft (four 180° strokes) or one rotation of the camshaft (four 90° strokes). In order for six firing stroke events to take place in four incremental movements of the camshaft (90° each) or four incremental movements of the crankshaft (180° each) it is conventional that these firing stroke events be initiated 120° apart with respect to the crankshaft rotation. To accomplish the initiation of six successive firing stroke events every 120° (1) the firing stroke event in cylinder 5 is initiated 120° after the initiation of the firing stroke in cylinder 1, (2) the firing stroke event in cylinder 3 is initiated 120° after the initiation of the firing stroke event in cylinder 5, (3), the firing stroke events of cylinders 6, 2 and 4 follow in the same sequence. Also in order to achieve six successive stroke initiations within two revolutions of the crankshaft 32 the cycles of commonly used pistons 1 and 6, 2 and 5 and 3 and 4 are 180° out of phase with respect to one another.

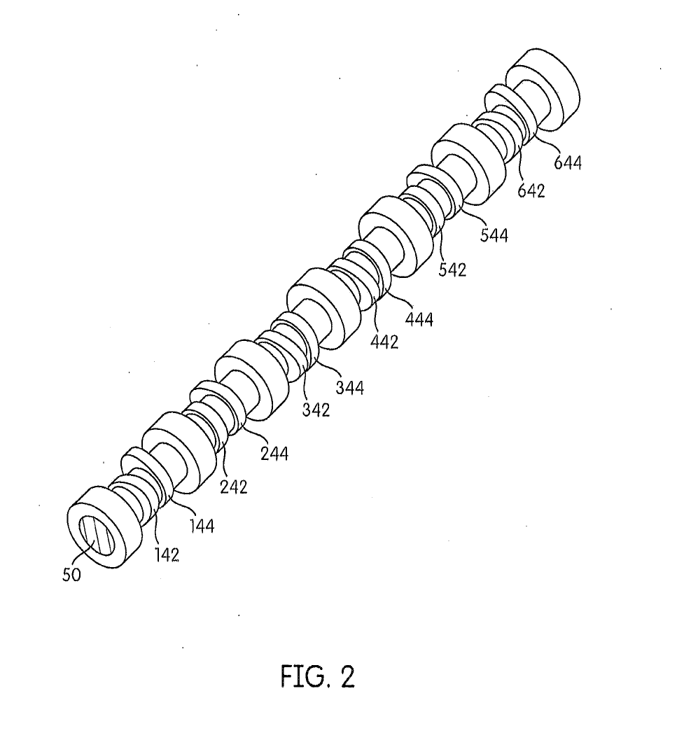

Referring now particularly to FIG. 2, there is shown therein a first modification for the conventional engine 10 in accordance with the principles of the present invention. The modification shown in FIG. 2 is a new camshaft 50 to replace the conventional camshaft 32. The camshaft 50 is constructed to allow the two adjacent piston and cylinder assemblies 3 and 4 to be done in phase rather than 180° out of phase. Compared with a conventional camshaft 32, new camshaft 50 has cam lobes 4 positioned on the camshaft in angular alignment rather than with cam lobe 3, as shown, being 180° out of alignment therewith. This alignment of cam lobes 3 and 4 allows pistons 3 and 4 to complete their combustion strokes simultaneously so that selectively both cylinder 3 and 4 will receive an injection of diesel fuel appropriate to fire both during the following simultaneous power strokes thereof or to alternatively inject only one cylinder 3 or 4 with an appropriate amount of fuel for one of cylinders 3 and 4 to fire alternatively in only one cylinder so that the increased pressure conditions resulting from the one fire can be communicated to the other cylinder. That is, the passage allows pressure generated by fuel injected and ignited in cylinder 3 or 4 to be communicated to the other of cylinders 3 or 4 receiving no fuel, so the pressure drives both pistons 3 and 4 simultaneously. This generates power of both pistons with one less injection charge.

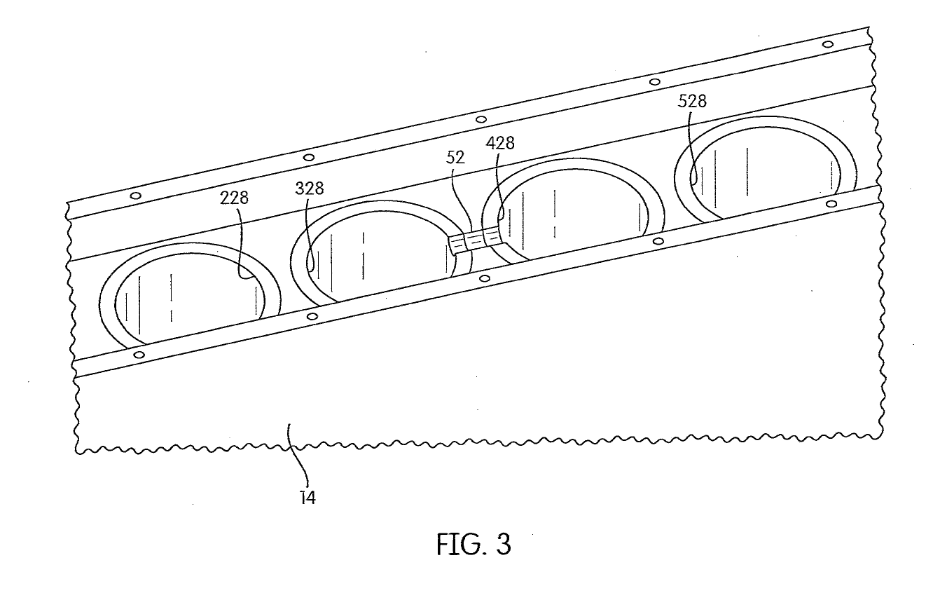

FIG. 3 shows the modification used to accomplish the communication. As shown, the modification is simply to remove from the seal engaging surface of the frame 12 extending between cylinders 3 and 4 sufficient material, as by grinding or other means, to form a passage 52 of a minimum size suitable to enable the communication to take place. Alternatively, a portion of the seal extending from cylinder 3 to cylinder 4 can be removed.

FIG. 4 shows the modifications sufficient to enable the mode selection to take place. FIG. 4 shows one computerized fuel injecting and firing system, generally indicated at 54, for an in line six cylinder engine operating as a diesel engine. The system 54 includes a fuel injector 56 for each cylinder 1-6. Each injector 56 has a source of fuel under pressure communicating therewith, which, as shown, includes a power driven pump 58 capable of delivering fuel from a tank 60 to a manifold 62 having a maximum pressure condition determined by a pressure relief valve 64 in line between the manifest 62 and tank 60. The manifold 62 communicates the fuel pressure therein directly to the six injectors 56.

Each injector 56 has a solenoid operated valve 66 formed therein for controlling the flow of fuel under pressure communicated therewith outwardly of a nozzle end thereof. In the cases of diesel operation, the nozzle end of each injector 56 is positioned to inject fuel directly into the combustion chamber of the associated cylinder 1-6. The solenoid operated valves 66 are controlled by electrical signals coming from a computer 68 which signals determine the time and amount of fuel injected to the associated injector 66.

Referring again to FIG. 2, there is shown therein a preferred further camshaft modification embodied in the new camshaft 50 enabling a preferred, more balanced application of the forces created by the firing events in the cylinders to the crankshaft 32. Specifically, the further modification is to change the movement of inlet and outlet valves 1 and 6 and the inlet and outlet valves 2 and 5 so that the cycles in cylinders 1-6 and 2-5 are in phase rather than being 180° out of phase. Compared with camshaft 32, new camshaft 50 preferably in addition to the angular alignment of cam lobes 3 and 4 has cam lobes 6 angularly aligned with cam lobes 1 and cam lobe 2 are angularly aligned with cam lobes 5. With these further modifications the firing stroke event is initiated in two cylinders simultaneously every 240° of rotation of the crankshaft 82.

As best shown in FIG. 4, preferably, the fuel injecting and firing system 48 includes modifications which allow a selected third mode of operation wherein alternating one of injections 1 and 6 and alternating one of injectors 2 and 5 is controlled to inject zero amount of fuel. That is, injectors 2 and 5 are being used in a known “skip-fire” style where no fuel or pressure from another source is being introduced into the associated cylinder. This third mode where cylinders 3 and 4 are also operating alternately with one injector injecting zero amount of fuel but receiving pressure from the other cylinder receiving fuel, can be identified as a maximum fuel saving mode (50% saving) whereas the previously identified fuel saving mode can be identified as an intermediate fuel saving mode (16-2/3%).

In the system 54 shown in FIG. 4, the selection of which of the three modes is to operate is left up to the driver of the vehicle. FIG. 4 illustrates a box 70 having three buttons 72, 74 and 76 which when pushed provide three different signals to the computer 58.

Preferably, the signal which activates the computer 68 to emit signals commensurate with the maximum power mode is made by pressing a manual control button 72 although it could be under the control of a sensor that activates when the vehicle is going up a steep grade or the gas pedal has been floor-boarded. Preferably, the signal which activates the computer to emit signals commensurate with the maximum fuel savings mode is the separate manual control button 74 although it could be activated when the cruise control button is turned on. It is noted that cylinders 3 and 4 will both fire in the maximum power mode, while only one will fire in the maximum fuel saving mode. And, when neither maximum mode is operating, the cylinders 3 and 4 will fire one alternately (the intermediate mode).

Consequently, the preferred operation of the fuel injecting and firing system 48 is to select the intermediate mode at all times (16-2/3% less fuel than max power), as by a third manual control button 76 except when added power is desired or needed (max power mode) or when the cruise control button is turned on (max fuel saving mode 50% less fuel than max power).

When the computer 48 receives a signal as a result of pushing button 72, the computer 48 is programmed to activate all of the injectors 50 at the appropriate time. When the computer 48 receives a signal as a result of pushing button 74, the computer in proper timed relation (1) alternate one of injectors 3 and 4 (2) alternate one of injectors 1 and 6 and (3) alternate one of injectors 2 and 5. When the computer 48 receives a signal as a result of pushing button 76, the computer 48 is programmed to activate in properly timed relation alternately one of injectors 3 and 4 and both injectors 1 and 6 and both injectors 2 and 5.

The modifications to be made in accordance with the principles of the present inventions are the same whether the engine is diesel ignited or spark plug ignited, In the case of a spark ignited engine the nozzle ends of the injectors 56 are directed along with a variable air supply into the cylinders through the open inlet vale during the intake stroke. While a spark plug is provided in each combustion chamber and a distributor assembly is also provided it is preferable to modify the distributor system so that when both cylinders 3 and 4 are to be fired together only one is fired and the fire in that one is used to fire the other through the communicating passage.

What characterizes the method of the present invention is that the in-line six engine starts with three pairs of simultaneously moving piston and cylinder assemblies: (1) an inner side-by-side pair of assemblies (3 and 4); (2) an intermediate spaced pair of assemblies (2 and 5) outside of the inner pair in side-by-side relation and (3) an outer spaced pair of assemblies (1 and 6) outside of the intermediate pair in side-by-side relation thereto.

The new camshaft makes the drive events of each pair to occur as a pair of simultaneous drive events, the three paired drive events occurring in evenly spaced relation to one another during each cycle as determined by 720° of crankshaft rotation. The new program in the computer/controller establishes a dual option injection choice for all three pairs of assemblies. Specifically, each pair of injectors operates either (1) in (Mode 1) where both injectors inject fuel or (2) in Mode 2 where only one of the two injectors inject fuel and the other is skipped. Skipping normally results in deactivating the cylinder which is skipped and this is what happens in the skipped one of the 1 and 6 pair and the 2 and 5 pair when operating in Mode 2 while the other cylinder of each pair under a directly fired power drive event. For the outer 1/6 pair and the intermediate 2/5 pair, this Mode 2 may be referred to as a skip-fire power drive event because one cylinder receives fuel and its piston is fired, while the other cylinder of that pair skipped for fuel injection. What happens in the skipped cylinder of the 3 and 4 pair is not deactivation. Instead, the skipped cylinder (3 or 4) shares, by virtue of the passage, the increased pressure conditions in its paired cylinder (the other one of 3 or 4) resulting from the directly fired power drive event occurring therein by virtue of the injection received. The result is that the 3 and 4 pair of assemblies undergo a pair of shared power drive events.

The fact is that there is a dual injection choice with each of three pairs of assemblies, enabling the engine to operate in five different power level steps wherein five different numbers of injections take place and where the injections have two different results in different pairs.

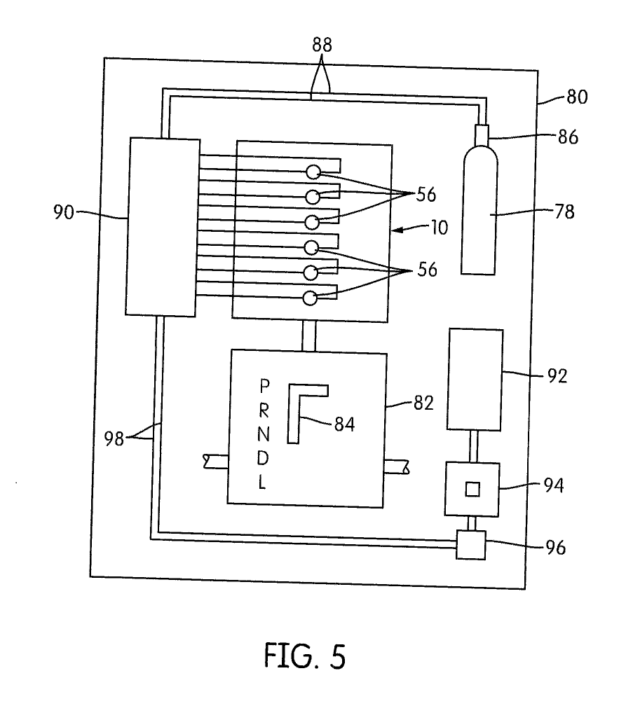

Referring now more particularly to FIG. 5, there is schematically shown therein in accelerator pedal 78 of a vehicle 80 wherein the engine 10 is mounted in driving relation to a lever controlled transmission 82 connected to move the vehicle 80. The lever controlled transmission 82 includes an idle position of the controlling lever 80 where the engine 10 operates and the transmission 82 is disconnected so as not to move the vehicle 80 and a number of drive positions where the transmission 82 is connected so that the engine 10 operation moves the vehicle 80.

As best shown in FIG. 5, the accelerator pedal 78 has a position sensor 86 operatively connected thereto which has the capability of transmitting position signals, through lines 88 to a computer 90, the signals being indicative of the position of the accelerator pedal. The computer 90 is configured to process the position signals received and determine the zone of pedal positions the pedal is in, including a low power zone of positions between the initial position and a first transition position of the pedal, a first intermediate power zone of positions between the first transition position and a second transition position of the pedal, a second intermediate power zone of positions between the second transition position and a third transition position of the pedal, and a high power zone of positions between the third transition position and the maximum displacement position of the pedal.

As a result of determining the power zone the pedal 78 is in, a zone signal indicative of the zone determined is transmitted to the injectors 56 of the three pairs of assemblies. The injectors 56 receive the zone signals as corresponding step signals so that the three pairs of assemblies operate in the desired power level step for the corresponding power zone determined.

Again referring to FIG. 5, the vehicle 80 preferably includes a conventional cruise control system, generally indicated at 92, which includes an activating unit 99 capable of activating the system 92 at a set speed. The system 92 is typically operable to set the speed at a minimum independent of the accelerator pedal position, but the driver may depress the pedal further to increase the speed above that maximum.

As best shown in FIG. 5, the cruise control system 92 of the vehicle 80 has a cruise control operation sensor 96 operatively associated with the activating unit 94 of the system 92. The sensor 90 senses when the activating unit 94 is activated and the continuation of the activation until the cruise control system is deactivated. As long as the computer 90 receives via leads 98 a signal from the sensor 96 indicative of continued activation, the pedal position signals may no longer be processed to determine zones but rather progressive amounts of fuel per injection. The reception of the cruise control signal is processed to establish continuous operation of the three pairs of assemblies in the low power step where a low of three injections occur during each cycle.

Consequently, anytime the cruise control system is activated and operative a 50% fuel saving is achieved with the power available being greater than 50% by virtue of the pair of shared power drive events occurring in the center pair of piston and cylinder assemblies (3 and 4).

Optionally, if the user depresses the accelerator pedal while the cruise control is activated, as to drive faster than the set cruise control speed, the zone signal determination process may be used as described herein to manage fuel injection and engine power beyond that needed for the set cruise control speed. The method of the present invention comprises operating the engine with the transmission in an idle lever position so that the three paired drive events occur equally spaced during a number of piston drive strokes equal to 720° of crankshaft rotation and making successive selected pedal movements between the idle position and the max position with the transmission in a drive position to move the vehicle at a desired speed by correspondingly changing the power delivered by the engine to the transmission commensurate with the selected pedal movement so that when the selected pedal movement is (1) through progressive pedal positions between the idle position and the first transition position wherein the three pairs operate in Mode 2 resulting in three paired drive events including one pair of shared power drive events (cylinders 3/4) and two skip-fire power drive events (cylinders 1/6 and 2/5) all with a skip of fuel injection in one cylinder for each of the three pairs, and the total amount of fuel injected power drive events progressively increases from an amount less than maximum at the initial position to a first maximum amount per injection at the first transition position; (2) through progressive pedal positions between the first transition position and the second transition position wherein the three paired drive events become one pair of shared power drive events (cylinders 3/4) with a skip in one cylinder of that pair, one pair with a skip-fire power drive event and a skip in one cylinder of that pair (e.g., cylinders 1/6 or 2/5), and one pair of directly fired power drive events with fuel injected to both cylinders and no skip (e.g., the other of cylinders 1/6 and 2/5), and the total amount of fuel injected progressively increases from the total amount injected at the first transition position to a second maximum amount for the added number of injections at the second transition position being made; (3) through progressive positions between the second transition position and the third transition position wherein the three paired drive events become one pair of shared power drive events (cylinders 3/4) with a skip in one cylinder of that pair and two pairs of directly fired power drive events with fuel injected to both cylinders of both pairs and no skip (cylinders 1/6 and 2/5), and the total amount of fuel injected progressively increases from an amount equal to the amount injected at the second transition position to a third maximum amount per injection at the third transition position for the added number of injections being made; and (4) through progressive positions between the third transition position and the max position wherein the three paired drive events all become three pairs of directly fired power drive events with no skips (i.e., fuel is delivered to all 6 cylinders), and the total amount of fuel injected progressively increases from an amount equal to the amount injected at the third transition position to a third maximum amount per injection at the fourth transition position for the added number of injection being made until the maxim amount is at the max pedal position.

It can be seen that the result of transmitting to the injectors a low power zone signal is to cause the three pairs of assemblies to operate in (Mode 2) at the low level step so that three out of six injections take place each cycle, resulting in a 50% fuel saving (which would normally provide an expected 50% retention of available power). However, because the 3 and 4 pair are sharing a pair of drive events, the available power is greater than 50% (an estimated 58 2/3%).

The result of transmitting to the injectors a first intermediate power zone signal is to change one of the 1 and 6 pair or 2 and 5 pair from operating in (Mode 2) to operate in (Mode 1). This adds one injection so that four out of six injections take place each cycle reducing the fuel savings from 50% to 33 1/3% with an increase in power available from a normally expected 50% to 66 2/3%. However, because the 3 and 0.4 pair are still sharing a pair of drive events, the power available is more than 66 2/3% (an estimated 71 1/3%).

The result of transmitting to the injectors a second intermediate zone signal is to change the other 1 and 6 pair or 2 and 5 pair from operating in (Mode 2) to operate in (Mode 1). Here again, this adds another injection so that five out of six injections take place each cycle reducing the fuel savings from 33 1/3% to 16 2/3% with an increase in available power from a normally expected 66 2/3 to 83 1/3%. Again, since the 3 and 4 pair is still sharing a pair of power drive events, the available power is more than 83 1/3% (an estimated 90%).

Finally, the result of transmitting a high power zone signal to the injector is to change the 3 and 4 pair from operating in (Mode 2) to operating in (Mode 1) so that now all six assemblies are receiving an injection and there is not fuel savings, but 100% of the power is available.

It should be appreciated that the foregoing embodiment(s) have been illustrated solely for the purposes of illustrating the structural and functional advantages of the present invention and is not intended to be limiting. To the contrary, the present invention includes all modifications, alterations, substitutions and equivalents within the spirit and scope of the appended claims.

1. A method of operating an engine to move a vehicle, the vehicle also having an accelerator pedal moveable between an initial position and a maximum position in a direction away from the initial position to progressively pass through first, second, and third transition positions each further away from the initial position and in an opposite direction away from the maximum position to progressively pass through the three transition positions in reverse;
the engine comprising:
a frame,
six piston and cylinder assemblies mounted in line in said frame,
a crankshaft,
a connecting rod between said crankshaft and a piston of each of said six assemblies constructed and arranged so that the pistons of a pair of inner adjacent assemblies, a pair of outer assemblies and a pair intermediate assemblies each move through repetitive cycles of reciprocating movement offset with respect to one another by 120° of crankshaft rotation and in which each cycle has four strokes of piston movement alternately in opposite directions which take place during four successive 180° rotational movements of said crankshaft,
a controlled fuel injecting and firing system including an injector for each assembly for injecting fuel into the cylinder thereof during a stroke of the associated piston therein so that a mixture of fuel and compressed air in the combustion chamber thereof can be ignited to affect a power stroke of the assembly immediately following the compression stroke thereof, and
a passage communicating the combustion chambers of the inner pair of piston and cylinder assemblies, the passage enabling a shared power event for the inner pair of piston and cylinder assemblies in which fuel injected in only one cylinder of the inner pair is ignited with a resultant increase in pressure therein being shared by said passage with the other cylinder of the inner pair that was skipped for fuel injection to affect simultaneous shared power drive strokes of both pistons of said inner pair;
the method comprising:
operating the engine so that the three paired drive events occur equally spaced during a number of piston drive strokes equal to 720° of crankshaft rotation, and
selectively moving the pedal between the initial position and the maximum position to cause movement of the vehicle;
correspondingly changing the power delivered by the engine commensurate with the selected pedal movement in accordance with the following:
(1) when the selected pedal movement is through progressive pedal positions between the initial position and the first transition position, the three pairs operate in a low power mode in which fuel is injected to one cylinder of each of the three pairs with a skip of fuel injection to the other cylinder of each of the three pairs so that the three paired drive events include the inner pair having said shared power drive event and the other two pairs having skip-fire power drive events, and the total amount of fuel injected progressively increases from an amount less than maximum at the initial position to a first maximum amount per injection at the first transition position;
(2) when the pedal positions progress between the first transition position and the second transition position, the three pairs operate in a first intermediate power mode in which fuel is injected to both cylinders of one of the intermediate and outer pairs and fuel is also injected into one cylinder of each of the other pairs, including the inner pair, with a skip of fuel injection to the other cylinder of said other pairs so that the three paired drive events include the inner pair having shared power drive event, said one of the intermediate and outer pairs having directly fired power drive events, and the other of said intermediate and outer pairs having a skip-fire power drive event, and the total amount of fuel injected progressively increases from the total amount injected at the first transition position to a second maximum amount for the added number of injections at the second transition position being made;
(3) when the pedal positions progress between the second transition position and the third transition position, the three pairs operate in a second intermediate power mode in which fuel is injected to both cylinders of both the intermediate and outer pairs and fuel is also injected into one cylinder of the inner pair with a skip of fuel injection to the other cylinder of said inner pair so that the three paired drive events include the inner pair having shared power drive event, and each of the intermediate and outer pairs having directly fired power drive events, and the total amount of fuel injected progressively increases from an amount equal to the amount injected at the second transition position to a third maximum amount per injection at the third transition position for the added number of injections being made; and
(4) when the pedal positions progress between the third transition position and the maximum position the three pairs operate in a high power mode in which fuel is injected to all the cylinder and the three paired drive events include three pairs of directly fired power drive events, and the total amount of fuel injected progressively increases from an amount equal to the amount injected at the third transition position to a third maximum amount per injection at the fourth transition position for the added number of injection being made until the maximum amount at the maximum pedal position.

2. A method as defined in claim 1 wherein the resultant step operation of the three pairs of assemblies from each of said progressive movements of pedal positions is accomplished by sensing the position of the accelerator pedal, transmitting a position signal from the sensor indicative of the position of the pedal, receiving the position signal and processing the received position signal to determine one of four power zones of pedal positions the pedal is in equivalent to the four power steps and transmitting a zone signal corresponding to an equivalent power step to the injectors of the three pairs of assemblies so that the three pairs of assemblies operate in the equivalent power step.

3. A method as defined in claim 2 wherein the vehicle includes a manually activated cruise control system capable when activated at a set speed to automatically move the accelerator pedal to obtain the set speed, sending a cruise control activation signal to the computer when the cruise control system is manually activated, sending only cruise control output signals from the computer to the injectors after the activation signal is received until a deactivation signal is received in response to the manual deactivation of the cruise control system, the cruise control signals of the computer selectively enabling the injectors of all four assemblies to remain in (Mode 2) with the amount of fuel injected from minimum to maximum being determined by the position the accelerator pedal is moved between idle and max respectively automatically by the cruise control system.

4. A method as defined in claim 3 wherein whenever the pair of injectors of any pair of assemblies are operating in (Mode 2) the output signals of the computer are operable to switch the cylinder of the assembly which receives the injection with the cylinder which is skipped an injection every predetermined number of cycles selected at random.

5. A method as defined in claim 4 wherein the events of the engine include procedures wherein the intake event of the engine includes an intake of air, the compression event includes a compression of the air taken in the intake event into an auto ignition pressure and temperature condition and when the cycle includes an injection of fuel, the injection takes place while the compressed air is in said auto ignition condition to effect a directly fired power drive event.

6. A method as defined in claim 4 wherein the events of the engine include procedures whereby when the cycle includes an injection of fuel, the injection takes place with a mixture of air during the intake event and the mixture of fuel and air is compressed during the compression event and ignite by an electrical spark to effect a directly fired power drive event.

7. A method as defined in claim 1 wherein the events of the engine include procedures wherein the intake event of the engine includes an intake of air, the compression event includes a compression of the air taken in the intake event into an auto ignition pressure and temperature condition and when the cycle includes an injection of fuel, the injection takes place while the compressed air is in said auto ignition condition to effect a directly fired power drive event.

8. A method as defined in claim 1 wherein the events of the engine include procedures whereby when the cycle includes an injection of fuel, the injection takes place with a mixture of air during the intake event and the mixture of fuel and air is compressed during the compression event and ignite by an electrical spark to effect a directly fired power drive event.

9. A method as defined in claim 1 wherein the vehicle includes a manually activated cruise control system capable when activated at a set speed to automatically move the accelerator pedal to obtain the set speed, sending a cruise control activation signal to the computer when the cruise control system is manually activated, sending only cruise control output signals from the computer to the injectors after the activation signal is received until a deactivation signal is received in response to the manual deactivation of the cruise control system. The cruise control signals of the computer selectively enabling the injectors of all four assemblies to remain in (Mode 2) with the amount of fuel injected from minimum to maximum being determined by the position the accelerator pedal is moved between idle and max respectively automatically b the cruise control system.

10. A method as defined in claim 1 wherein whatever the pair of injectors of any pair of assemblies are operating in (Mode 2) the output signals of the computer are operable to switch the cylinder of the assembly which receives the injection with the cylinder which is skipped an injection every predetermined number of cycles selected at random.

11. An internal combustion engine for a vehicle, the vehicle also having an accelerator pedal moveable between an initial position and a maximum position in a direction away from the initial position to progressively pass through first, second, and third transition positions each further away from the initial position and in an opposite direction away from the maximum position to progressively pass through the three transition positions in reverse;
the engine comprising:
a frame,
six piston and cylinder assemblies mounted in line in said frame,
a crankshaft,
a connecting rod between said crankshaft and a piston of each of said six assemblies constructed and arranged so that the pistons of a pair of inner adjacent assemblies, a pair of outer assemblies and a pair intermediate assemblies each move through repetitive cycles of reciprocating movement offset with respect to one another by 120° of crankshaft rotation and in which each cycle has four strokes of piston movement alternately in opposite directions which take place during four successive 180° rotational movements of said crankshaft,
a controlled fuel injecting and firing system including an injector for each assembly for injecting fuel into the cylinder thereof during a stroke of the associated piston therein so that a mixture of fuel and compressed air in the combustion chamber thereof can be ignited to affect a power stroke of the assembly immediately following the compression stroke thereof, and
a passage communicating the combustion chambers of the inner pair of piston and cylinder assemblies, the passage enabling a shared power event for the inner pair of piston and cylinder assemblies in which fuel injected in only one cylinder of the inner pair is ignited with a resultant increase in pressure therein being shared by said passage with the other cylinder of the inner pair that was skipped for fuel injection to affect simultaneous shared power drive strokes of both pistons of said inner pair;
said fuel injecting and firing system including a controller that receives a signal indicative of a position of the pedal and is configured to correspondingly change the power delivered by the engine commensurate with the selected pedal movement by operating the fuel injectors in accordance with the following:
(1) when the selected pedal movement is through progressive pedal positions between the initial position and the first transition position, the three pairs operate in a low power mode in which fuel is injected to one cylinder of each of the three pairs with a skip of fuel injection to the other cylinder of each of the three pairs so that the three paired drive events include the inner pair having said shared power drive event and the other two pairs having skip-fire power drive events, and the total amount of fuel injected progressively increases from an amount less than maximum at the initial position to a first maximum amount per injection at the first transition position;
(2) when the pedal positions progress between the first transition position and the second transition position, the three pairs operate in a first intermediate power mode in which fuel is injected to both cylinders of one of the intermediate and outer pairs and fuel is also injected into one cylinder of each of the other pairs, including the inner pair, with a skip of fuel injection to the other cylinder of said other pairs so that the three paired drive events include the inner pair having shared power drive event, said one of the intermediate and outer pairs having directly fired power drive events, and the other of said intermediate and outer pairs having a skip-fire power drive event, and the total amount of fuel injected progressively increases from the total amount injected at the first transition position to a second maximum amount for the added number of injections at the second transition position being made;
(3) when the pedal positions progress between the second transition position and the third transition position, the three pairs operate in a second intermediate power mode in which fuel is injected to both cylinders of both the intermediate and outer pairs and fuel is also injected into one cylinder of the inner pair with a skip of fuel injection to the other cylinder of said inner pair so that the three paired drive events include the inner pair having shared power drive event, and each of the intermediate and outer pairs having directly fired power drive events, and the total amount of fuel injected progressively increases from an amount equal to the amount injected at the second transition position to a third maximum amount per injection at the third transition position for the added number of injections being made; and
(4) when the pedal positions progress between the third transition position and the maximum position the three pairs operate in a high power mode in which fuel is injected to all the cylinder and the three paired drive events include three pairs of directly fired power drive events, and the total amount of fuel injected progressively increases from an amount equal to the amount injected at the third transition position to a third maximum amount per injection at the fourth transition position for the added number of injection being made until the maximum amount at the maximum pedal position.

12. An internal combustion engine as defined in claim 11 wherein a sensor is provided in cooperating relation with said accelerator pedal constructed and arranged to transmit position signals indicative of the position the accelerator pedal to the controller, and the controller is configured to (1) receive the pedal position signals transmitted, and (2) process the pedal position signals received to determine which one of four progressive power zones of pedal positions the pedal is in and (3) transmit signals to the injectors of the pairs of assemblies indicative of a power level step equivalent to the power zone indicative of the zone signal received causing the three pairs of assemblies to operate in the power level step of the signal.

13. An internal combustion engine as defined in claim 11 wherein the intake event includes an intake of air, the compression event includes a compression of the air taken in the intake event into an auto ignition pressure and temperature condition and when the cycle includes an injection of fuel the injection takes place while the compressed air is in said auto ignition condition to effect a directly fired power drive event.

14. An internal combustion engine as defined in claim 11 wherein when the cycle includes an injection of fuel, the injection takes place with a mixture of air during the intake event and the mixture of fuel and air is compressed during the compression event and ignited by an electrical spark to effect a directly fired power drive event.
